(19) United States
(12) Patent Application Publication
(10) Pub. No.: US 2025/0158379 A1
(43) Pub. Date: May 15, 2025

(54) FLAME PROOF CABLE GLAND WITH INSPECTABLE QUICK CONNECTOR

(71) Applicant: EATON INTELLIGENT POWER LIMITED, DUBLIN (IE)

(72) Inventors: Sujit Tarade, Ahmednagar (IN); Mark Feather, O'Fallon, IL (US); Himanshu Khokle, Nagpur (IN)

(21) Appl. No.: 18/937,922

(22) Filed: Nov. 5, 2024

(30) Foreign Application Priority Data
Nov. 10, 2023 (IN) 202311076984
Aug. 29, 2024 (IN) 202411065250

(51) Int. Cl. H02G 15/06; H02G 15/04

(52) U.S. Cl. CPC H02G 15/06; H02G 15/04

(57) ABSTRACT

A cable gland assembly includes a hub body, wherein an exterior portion of a second end of the hub body includes a multistart threaded portion. An intermediate body having a first end that is disposed within the hub body, and a second end having an annular projection disposed around an exterior portion of the second end of the intermediate body proximate to the second end of the hub body, the second end having external threads. A union nut defining an internal passage that receives the intermediate body and the second end of the hub body, a first end of the union nut threadedly engages the multistart threaded portion of the hub body. Tightening the union nut along the multistart threaded portion secures the intermediate body in the hub body. A gland nut having a first end that threadedly engages the external threads of the second end of the intimidate body.

### CROSS-REFERENCE TO RELATED APPLICATIONS

This application claims priority to Indian Provisional Application No. 202311076984, filed on Nov. 10, 2023. This application also claims priority to Indian Provisional Application No. 20/241,1065250, filed on Aug. 29, 2024. The disclosures of each of these documents are incorporated by reference herein in their entirety.

### FIELD OF INVENTION

The present disclosure relates generally to a cable gland. More particularly, the present disclosure relates to a cable gland having a union nut that is configured to quick release.

### BACKGROUND

Cable glands are used for terminating cables in hazardous and nonhazardous environments. More specifically, cable glands generally provide a means for terminating cables, such as unarmored cables (e.g., TC-type) and armored cables, at junction boxes, control centers, panelboards, enclosures, structures, and the like. Known cable glands are used to seal the junction between a cable and a device or a structure into which the cable is extending.

Additionally, existing cable gland assemblies may be assembled from several components. At various times, the cable assembly may need to be disassembled or reassembled, particularly for inspection purposes or for applying sealant. During disassembly, the numerous components of a conventional cable gland may come apart, including those that do not need to separate for purposes of the disassembly. This makes disassembly and reassembly of the cable gland assembly more complex, time consuming, and error prone. Furthermore, environmental debris may enter the cable gland from mating points of certain components as conventional cable gland assemblies may not provide a robust enough seal between certain components. This may lead to degradation of the cable or conductor and reduce the quality of the cable gland.

### SUMMARY OF THE INVENTION

In one embodiment, a cable gland assembly includes a hub body having a first end configured to threadedly couple to a structure and a second end opposite the first end, wherein an exterior portion of the second end of the hub body includes a multistart threaded portion, the hub body defining an internal passage. The cable gland assembly further includes an intermediate body extending along an axis, the intermediate body having a first end and a second end, the intermediate body defining an internal passage that is configured to receive a cable, the first end of the intermediate body is disposed within the internal passage of the hub body, the second end extending axially past the second end of the hub body, the second end further having an annular projection disposed around a first exterior portion of the second end of the intermediate body proximate to the second end of the hub body, the second end further having external threads extending axially past the annular projection along a second exterior portion of the intermediate body. The cable gland assembly further includes a union nut having a first end and a second end opposite the first end, the union nut defining an internal passage that receives the intermediate body and the second end of the hub body, the first end of the union nut threadedly engages the multistart threaded portion of the hub body, the second end of the union nut having a shoulder that abuts against the annular projection of the intermediate body, wherein tightening the union nut along the multistart threaded portion of the hub body secures the intermediate body in the internal passage of the hub body. The cable gland assembly further includes a gland nut having a first end and a second end opposite the first end, the gland nut defining an internal passage configured to receive the cable, the first end of the gland nut threadedly engages the external threads of the second end of the intimidate body, the second end of the gland nut having a shoulder.

In another embodiment, a cable gland assembly includes a hub body extending along an axis having a first end configured to threadedly couple to a structure and a second end opposite the first end, the hub body defining an internal passage along the axis that is configured to receive a portion of a cable, the second end of the hub body including an aperture extending perpendicular to the axis into the internal passage of the hub body. The cable gland assembly further includes an intermediate body having a first end and a second end opposite the first end, the intermediate body defining an internal passage configured to receive a portion of the cable, wherein the first end of the intermediate body is received in the hub body, the first end of the intermediate body having a blind hole, wherein the blind hole is aligned with the hub body aperture and extends perpendicular to the axis into the intermediate body. The cable gland assembly further includes an engagement pin configured to be inserted into the hub body aperture and intermediate body blind hole to secure the intermediate body in the hub body. The cable gland assembly further includes a gland nut having a first end and an opposite second end, the gland nut defining an internal passage configured to receive a portion of the cable, the first end of the gland nut receives the second end of the intermediate body such that the first end of the gland nut threadedly engage the threads of the second end of the intermediate body, the first end of the gland nut fits within the internal passage of the hub body.

In yet another embodiment, a cable gland assembly includes a hub body having a first end configured to threadedly couple to a structure and a second end opposite the first end, wherein the second end of the hub body includes an aperture that retains a ball bearing, the hub body defining an internal passage. The cable gland assembly further includes an intermediate body extending along an axis, the intermediate body having a first end and a second end, the intermediate body defining an internal passage that is configured to receive a cable, the first end of the intermediate body is disposed within the internal passage of the hub body, the first end further having a channel that is aligned with aperture in the hub body and the channel receives the ball bearing through the aperture in the hub body, the second end of the intermediate body extends axially past the second end of the hub body, the second end of the intermediate body having external threads. The cable gland assembly further includes a union collar having a first end and a second end opposite the first end, wherein the union collar is substantially ring shaped such that the union collar includes an axially exterior surface and an axially interior surface, the axially interior surface of the union collar defines an internal passage that receives the second end of the hub body, the axially interior surface includes a projection that engages the ball bearing when the union collar is in a first position and disengages the ball bearing when the union collar is in a second position. The cable gland assembly further includes a gland nut having a first end and a second end opposite the first end, the gland nut defining an internal passage configure to receive the cable, the first end of the gland nut is configured to threadedly engage the external threads of the second end of the intermediate body, the second end of the gland nut having a shoulder.

In still another embodiment, a cable gland assembly includes a hub body having a first end configured to threadedly couple to a structure and a second end opposite the first end, wherein an exterior portion of the second end of the hub body includes a multistart threaded portion, the hub body defining an internal passage. The cable gland assembly further includes an intermediate body extending along an axis, the intermediate body having a first end and a second end, the intermediate body defining an internal passage, the first end of the intermediate body is disposed within the internal passage of the hub body, the second end extending axially past the second end of the hub body, the second end further having a collar, the intermediate body having further having internal threads along a portion of the internal passage proximate to the second end of intermediate body. The cable gland assembly further includes an elbow body having a first end and a second end, the elbow body further having an angular bend disposed between the first end and second end of the elbow body, the elbow body defining an internal passage, the first end of the elbow body threadedly engages the internal threads of the intermediate body, the second end of the elbow body includes external threads. The cable gland assembly further includes a union nut having a first end and a second end opposite the first end, the union nut defining an internal passage that receives the first end of the intermediate body and the second end of the hub body, the first end of the union nut threadedly engages the multistart threaded portion of the hub body, the second end of the union nut having a shoulder that abuts against the intermediate body collar, wherein tightening the union nut along the multistart threaded portion of the hub body secures the intermediate body in the internal passage of the hub body. The cable gland assembly further includes a gland nut having a first end and a second end opposite the first end, the gland nut defining an internal passage, the first end of the gland nut threadedly engages the external threads of the second end of the elbow body, the second end of the gland nut having a shoulder.

### BRIEF DESCRIPTION OF DRAWINGS

In the accompanying drawings, structures are illustrated that, together with the detailed description provided below, describe exemplary embodiments of the claimed invention. Like elements are identified with the same reference numerals. It should be understood that elements shown as a single component may be replaced with multiple components, and elements shown as multiple components may be replaced with a single component. The drawings are not to scale, and the proportion of certain elements may be exaggerated for the purpose of illustration.

FIG. 1 is a cross sectional view of one embodiment of a cable gland assembly,

FIG. 2 is a cross sectional view of one embodiment of an exemplary hub body and union nut with multistart threaded portions,

FIG. 3 is a side view of the exemplary hub body of FIG. 2,

FIG. 4 is a second end perspective view of the exemplary hub body of FIG. 2,

FIG. 5 is a cross sectional view of one embodiment of a cable gland assembly including a grub screw,

FIG. 6 is a cross sectional view of one embodiment of a cable gland assembly including a spring-loaded plunger,

FIG. 7 is a cross sectional view of one embodiment of a cable gland assembly including a union collar,

FIG. 8 is a side view of the cable gland assembly of FIG. 7, and

FIG. 9 is a cross sectional view of one embodiment of a cable gland assembly including an elbow body.

FIG. 10 is a cross sectional view of one embodiment of a cable gland assembly including rotational resistance features,

FIG. 11 is a second end perspective, exploded view of the cable gland assembly of FIG. 10,

FIG. 12 is a first end perspective view of an exemplary hub body and an exemplary intermediate body of the cable gland assembly of FIG. 10,

FIG. 13 is a second end perspective, cross sectional view of the hub body and intermediate body of FIG. 12,

FIG. 14 is a second end perspective view of the hub body of FIG. 12, and

FIG. 15 is a first end perspective view of the intermediate body of FIG. 12.

### DETAILED DESCRIPTION

Known flame proof cable glands include a hub body for threadedly engaging with a structure, an intermediate body for threadedly engaging with the hub body, and a gland nut for threadedly engaging with the intermediate body. Therefore, such configurations securing a cable within the cable gland require an installer to torque three different components. Additionally, some known cable glands need to be disassembled or reassembled. During disassembly, the numerous components of known cable glands may come apart, including those that do not need to separate for purposes of the disassembly. This makes disassembly and reassembly of the cable gland assembly more complex, time consuming, and error prone. Additionally, environmental debris may enter the cable gland from mating points of certain components as known cable gland may not provide a robust enough seal between certain components. This may lead to degradation of the cable and reduce the quality of the cable gland. One instance where existing cable glands may need to be disassembled is to apply a sealant in the hub body. Applying the sealant requires the union nut and gland nut to be disassembled to access the internal passage of the hub body. This process is time consuming and if the fittings are not replaced properly, it can lead to system failures. The present disclosure overcomes these deficiencies and other deficiencies in the prior art.

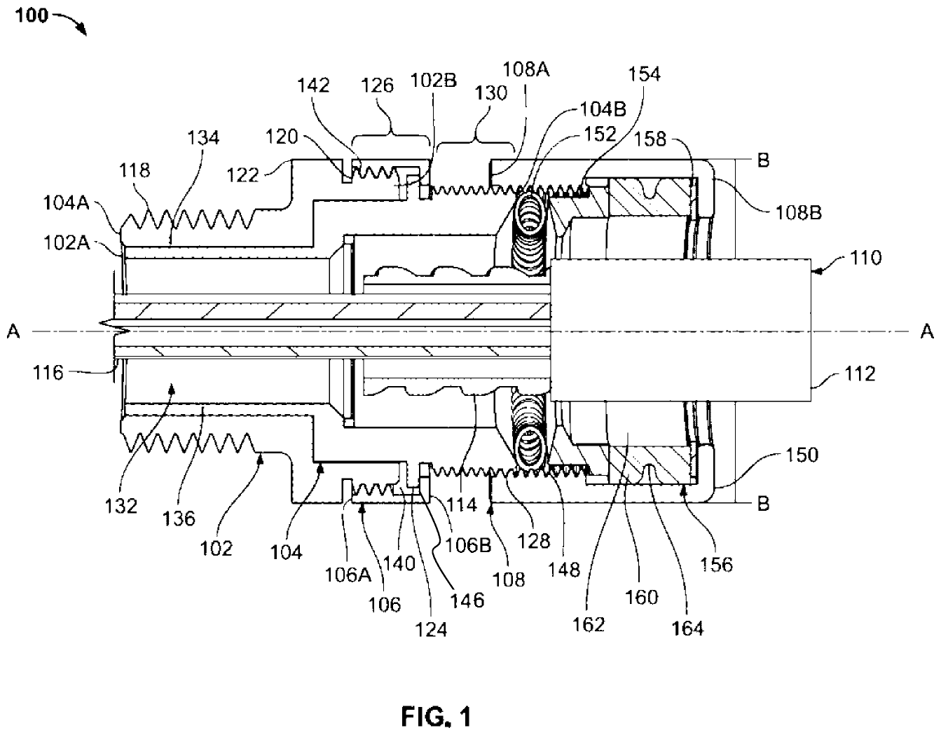

A first exemplary embodiment of a cable gland assembly that extends along an axis-A is depicted in FIG. 1. The cable gland assembly 100, more specifically, is a flame proof cable gland assembly that is configured to seal the junction between a cable 110 and a device or a structure into which the cable 110 is extending. In the illustrated embodiment, the cable 110 includes a cable jacket 112 that is disposed around a cable armor 114, which houses internal wires or cables 116. As explained in more detail below, the cable gland assembly 100 includes a union nut 106 that is threadedly coupled to a hub body 102 with a quick connector such that the union nut 106 can be uncoupled from the hub body 102 within one turn of the union nut 106. The other components of the cable gland assembly 100, also described below, are illustrative and may be of other designs or constructions.

The cable gland assembly 100 includes a hub body 102, an intermediate body 104, a union nut 106, and a gland nut 108, wherein the cable gland assembly 100 is configured to secure a portion of a cable 110 therein. The hub body 102 has a first end 102A with external connection threads 118 for threading into a device, an enclosure, or other structure. The hub body 102 further includes a second end 102B having a multistart threaded portion 120 that includes multistart threads for threadedly mating with the union nut 106. The hub body 102 further includes an internal passage that extends through the first end 102A and the second end 102B of the hub body 102. The hub body 102 may be formed from a metal, such as aluminum, stainless steel, or brass. The hub body 102 further includes a tool coupling portion 122 (e.g., a hexagonal or other polygonal structure) to aid in torquing the hub body 102 onto the structure.

The hub body 102 receives the intermediate body 104 in the internal passage of the hub body 102. The intermediate body 104 has a first end 104A and a second end 104B opposite of the first end 104A. The first end 104A of the intermediate body 104 is disposed within the internal passage of the hub body 104. The second end 104B of the intermediate body 104 extends axially outwards past the second end 102B of the hub body 102. The second end 104B of the intermediate body 104 includes an annular projection 124 disposed around a first portion 126 of the exterior surface of the intermediate body 104. The annular projection 124 is disposed on the second end 104B of the intermediate body 104 at a location that is proximate to the second end 102B of the hub body 102. The second end 104B of the intermediate body 104 further includes external threads 128 disposed around a second portion 130 of the exterior surface of the intermediate body 104. The external threads 128 of the second end 104B of the intermediate body 104 are configured to mate with and couple to the gland nut 102. The second portion 130 of the exterior surface of the intermediate body 104 is axially rearward of the first portion 126 of the exterior surface of the intermediate body 104 such that the annular projection 124 is positioned between the second end 102B of the hub body 102 and the external threads 128 of the intermediate body 104.

The intermediate body 104 further includes an internal passage 132 that extends through the first and second end 104A, 104B of the intermediate body 104. The internal passage 132 is configured to receive a portion of the cable 110 therein. The intermediate body 104 may be formed from a metal, such as aluminum, stainless steel, or brass. The cable gland assembly 100 may further include a flamepath 134. The flamepath 134 is a thin passage disposed between the interior surface of the hub body 102 and the exterior surface of the intermediate body 104. The flamepath 134 is configured to permit hot or volatile gasses that are contained within the structure to slowly dissipate from the structure. The flamepath 134 alleviates buildup of gasses within the structure, which if not alleviated, could lead to catastrophic failure of the system. Furthermore, the flamepath 134 may be configured such that it allows the hot gasses that are dissipating through the flamepath 134 to cool as the gasses travel through the flamepath 134 and out of the cable gland assembly 100.

The cable gland assembly 100 may further include a compound chamber 136 disposed within the intermediate body 104 proximate to the first end 104A of the intermediate body 104. The compound chamber 136 is configured to receive a curable sealing compound (also referred herein as a compound sealant). When cured, the sealing compound serves as a sealant within the cable gland assembly 100 that restricts the passage of gases, vapor, or flames into and through the cable gland assembly 100. Suitable examples of sealing compounds include, but are not limited to, epoxy fillers and Chico® sealing compounds commercially available from Eaton Corporation PLC.

The union nut 106 includes a first end 106A, and a second end 106B opposite of the first end 106A. The union nut 106 further includes an internal passage 140 that extends through the first and second ends 106A, 106B. The first end of the union nut 106A includes a multistart threaded portion 142. The multistart threaded portion 142 includes multistart threads that are configured to mate and couple to the multistart threads 120 of the hub body 102. The union nut 106 multistart threads 142 are disposed along an axially inner surface 144 of the union nut 106. The multistart threaded portion 142 of the union nut 106 and the multistart threaded portion 120 of the hub body 102 are configured as quick connectors such that the union nut 106 can be tightened to threadedly engage the hub body 102 and loosened to threadedly disengage from the hub body 102 in one or fewer turns. In alternate embodiments, the union nut 106 can be tightened to threadedly engage the hub body 102 and loosened to threadedly disengage from the hub body 102 in two or fewer turns. In alternate embodiments, the multistart threaded portions 120, 142 of the hub body 102 and union nut 106 may be comprised of standard threaded portions.

The second end 106B of the union nut 106 includes a shoulder 146 such that the opening at the first end 106B of the union nut 106 is wider than the opening at the second end 106B of the union nut 106. The internal passage 140 of the union nut 106 receives the intermediate body 104 such that the annular projection 124 of intermediate body 104 abuts the union nut shoulder 146. The shoulder 146 restricts the axial movement of the intermediate body 104 along the axis-A such that intermediate body 104 can only be inserted into the internal passage 140 of the union nut 106 until the annular projection 124 makes contact with the shoulder 146. The shoulder 146 further restricts the axial movement of the intermediate body 104 such that tightening the multistart threaded portion 142 of the union nut 106 to the multistart threaded portion 120 of the hub body 102 secures the intermediate body 104 in the internal passage of the hub body 102. The intermediate body 104 cannot be removed from the internal passage of the hub body 102 unless and until the union nut 106 is uncoupled from the hub body 102 such that the shoulder 146 of the union nut 106 does not abut the intermediate body annular projection 124.

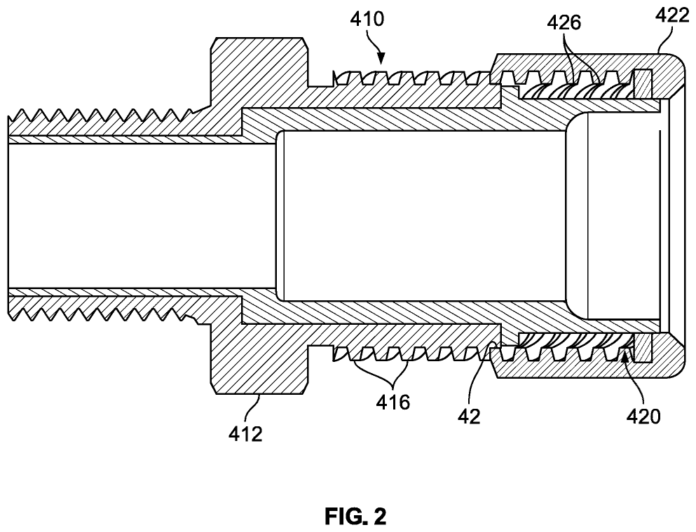

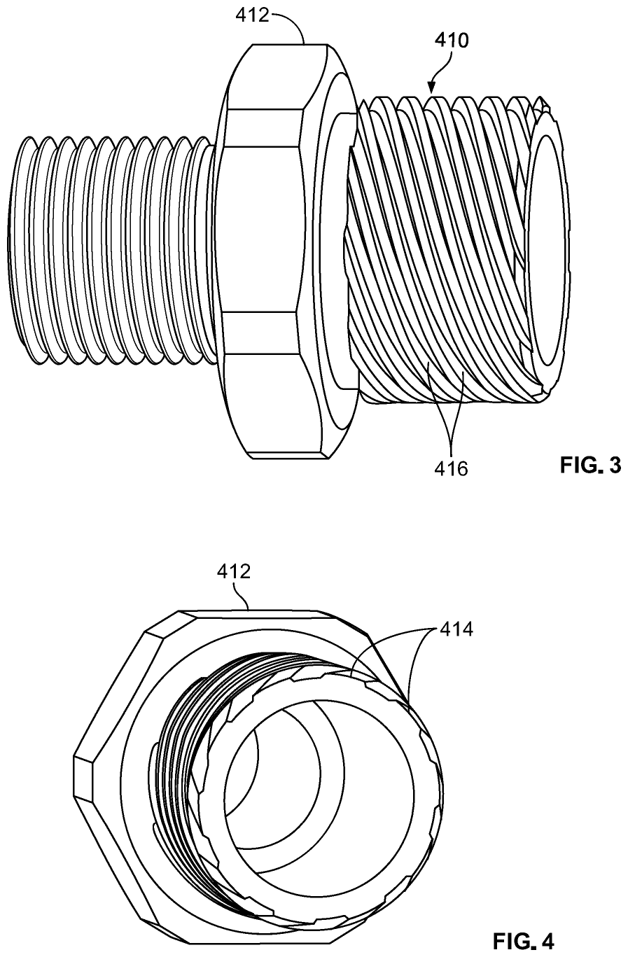

Referring now to FIGS. 2-4, which depict exemplary multistart threaded portions 410, 420 of an exemplary hub body 412 and an exemplary union nut 422. While there are slight variations between the exemplary hub body 412 and exemplary union nut 422 compared to the hub body 102 and union nut 106 of FIG. 1, these components function the same. The multistart threads 410, 420 are configured to reduce the number of rotations to torque the union nut 422 to the hub body 412. The exemplary multistart threaded portions 410, 420 are comprised of 1″-10 (ten threads per inch) threaded portions. The multistart threaded portions 410, 420 include ten start leads 414 that correspond with the threads 416, 426 of the ten threads per inch. In this configuration, each rotation of the union nut 420 translates 1 inch.

Referring again to FIG. 1, the gland nut 108 includes a first end 108A, and a second end 108B opposite of the first end 108A. The gland nut 108 further includes an internal passage that extends through the first and second ends 108A, 108B of the gland nut 108. The gland nut internal passage is configured to receive a portion of the cable 110 therethrough. The first end 108A of the gland nut 108 includes an opening that is sized to receive the second end 104B of the intermediate body 104. The first end 108 of the gland nut 108A includes internal threads 148 that are configured to mate with and threadedly engage the external threads 128 of the second end 104B of the intermediate body 104. The second end 108B of the gland nut 108 includes a shoulder 150 such that the opening at the first end 108A is wider than the opening at the second end 108B. The gland nut may be formed from a metal, such as aluminum, stainless steel, or brass.

The cable gland assembly 100 further includes a garter spring 152, a sleeve 154, a bushing 156, and a washer 158 disposed within the internal passage of the gland nut 108. The garter spring 152 is positioned between the second end 104B of the intermediate body 104 and the sleeve 154. The sleeve 154 is positioned between the garter spring 152 and the bushing 156. The sleeve 154 is configured to engage the garter spring 152 and the bushing 156 such that the sleeve 154 axially compresses the garter spring 152 and the bushing 156. The sleeve 154 may be comprised of or formed from, for example, plastic or metal, such as aluminum, stainless steel, or brass. The washer 158 is disposed between the bushing 156 and the shoulder 150 of the gland nut 108 proximate to the second end 108B of the gland nut 108. The washer 158 distributes the load applied by the shoulder 150 of the gland nut 108 when the cable gland assembly 100 is assembled. The washer 158 may be comprised of or formed from. for example, plastic, such as a polyamide.

When the cable gland assembly is assembled, the garter spring 152 is compressed between the second end 104B of the intermediate body 104 and the sleeve 154. When compressed, the garter spring 152 engages and surrounds the cable armor 114 to create a grounding connection. Additionally, the garter spring 152 may be configured to act as an armor stop which limits the insertion of the cable jacket 112 and the cable armor 114 of the cable 110 in the cable gland assembly 100 by stripping the cable jacket 112 and the cable armor 114 back to expose the internal wires or cables 116. The garter spring 152 may be formed from metal, such as stainless steel with copper flash coating.

The bushing 156 includes a bushing body 160 having a generally annular shape with an interior surface defining a bushing opening 162 extending through first and second ends of the bushing body 160A, 160B. A rib 164 is disposed on the interior surface of the bushing body. The rib 164 extends around the axis-A and extends radially inward from the interior surface toward the axis-A. In the illustrated embodiment, the rib 164 is a continuous annulus extending along the interior surface. The rib 164 may be disposed in a midplane extending through the bushing body 160 transverse to the axis-A at a location generally midway between the first and second ends of the bushing body 160A, 160B. The rib 164 may be disposed at other locations along the axis-A of the bushing body 160. The rib 164 has a suitable cross-sectional shape for engaging and sealing around the cable 110 received in the cable gland assembly 100.

The cable 110 is secured in the cable gland assembly 100 by the garter spring 152 and the bushing 156. The cable gland assembly 100 is configured such that the cable 110 remains secured in the intermediate body 104 and the gland nut 108 even when the union nut 106 is uncoupled form the hub body 102. As discussed above, when the gland nut is threadedly coupled to the intermediate body 104, the gland nut 108 secures a portion of the cable 100 in the intermediate body 104 and the gland nut 108 by compressing the cable 110 in the garter spring 152 and the bushing 156. Therefore, so long as the gland nut 108 is threadedly coupled to the intermediate body 104, then the garter spring 152 and bushing 156 remain in a compressed state such that the cable 110 is secured therein. This allows the union nut 106 to be uncoupled from the cable gland assembly 100 without compromising the securement of the cable 110.

After the union nut 106 is uncoupled form the hub body 102, then the intermediate body 104 can be removed from the internal passage of the hub body 102. Once the intermediate body 104 is removed from the internal passage of the hub body 102, an operator can apply the compound sealant or inspect previously applied compound sealant in the compound chamber 136 of the internal passage 132 of the intermediate body 104. Since the intermediate body 104 is received in the hub body 103 without fasteners or threads, then an operator only needs to untorque the union nut 106 to remove the intermediate body 104 to apply the compound sealant or inspect previously applied sealant.

In one embodiment, the cable gland assembly 100 has a ½ trade size fitting for use with 0.50 inch cables. The cable gland assembly 100 has an across corner width B-B of less than or equal to 1.24 inches with a sealing range of 0.50-0.78 inches. The cable gland assembly is an improvement over conventional cable glands because to achieve a similar sealing range, the conventional cable glands have an across corner width that is greater than 1.24 in (inches).

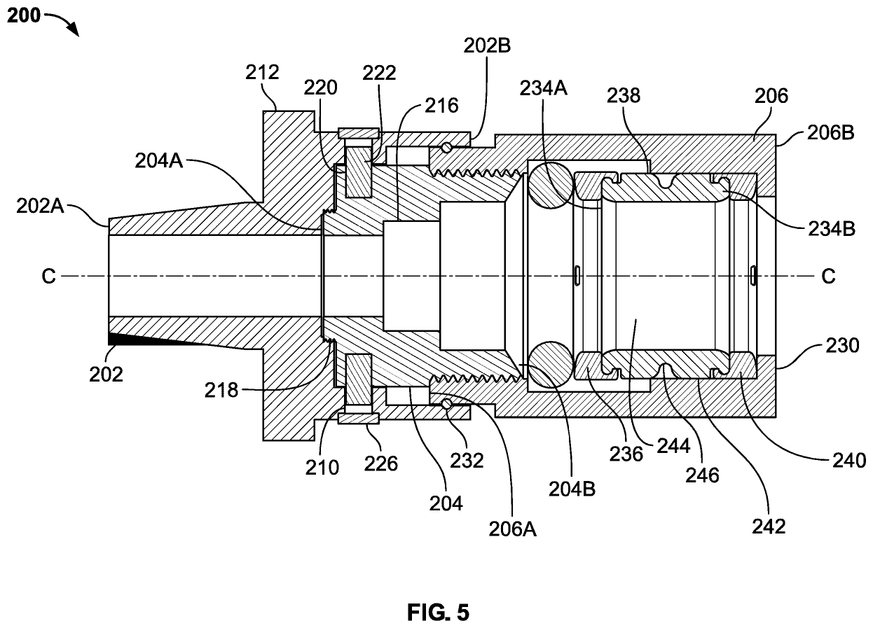

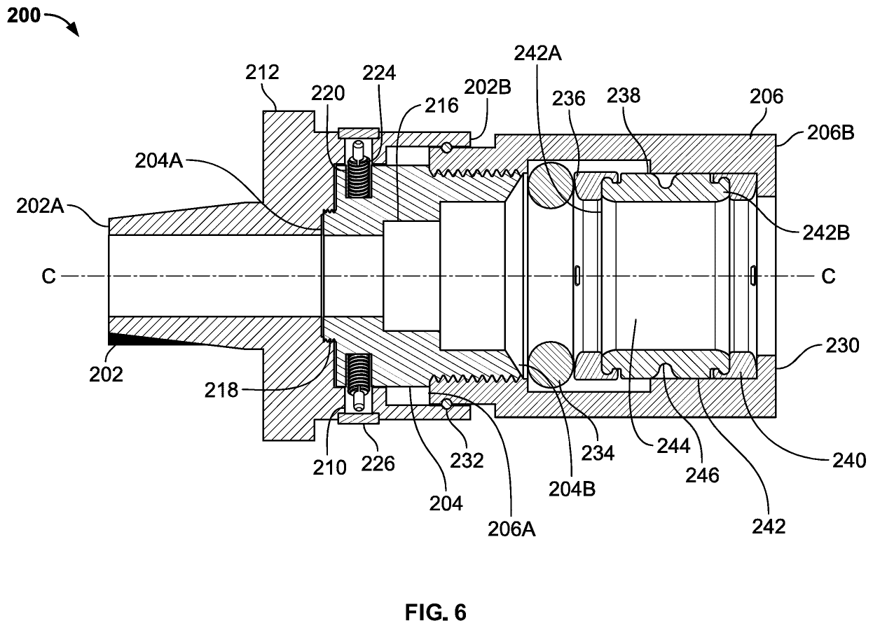

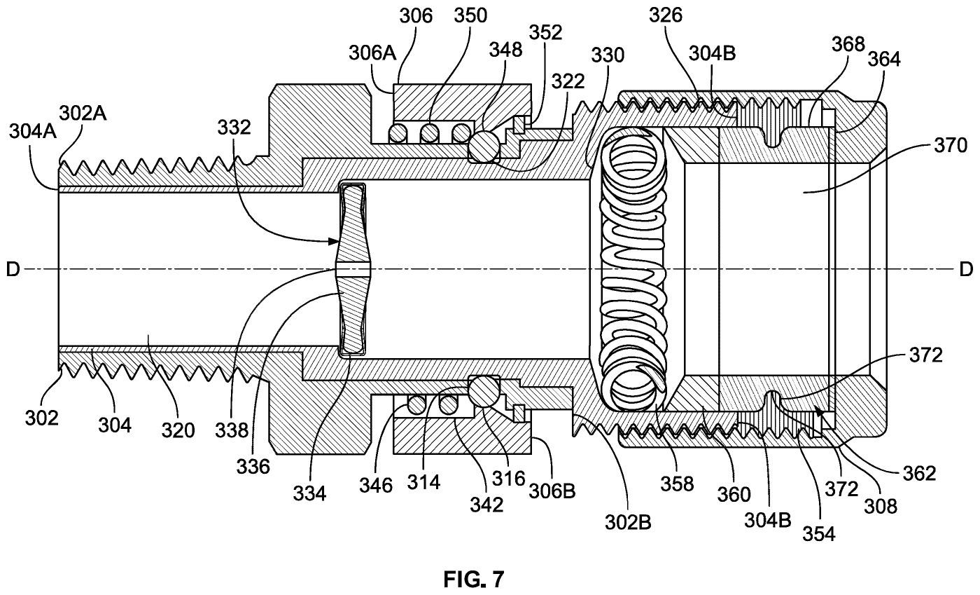

A second exemplary embodiment of a cable gland assembly that extends along an axis-C is depicted in FIGS. 5 and 6. The cable gland assembly 200 includes a hub body 202, an intermediate body 204, and a gland nut 206, wherein the cable gland assembly 200 is configured to secure a portion of a cable therein. The hub body 202 has a first end 202A, and a second end 202B that is opposite the first end. The hub body 202 further includes an internal passage that extends through the first end 202A and the second end 202B of the hub body 202. The first end 202A of the hub body 202 is configured to threadedly couple to a device, an enclosure, or other structure. The hub body 202 further includes a second end 202B having an aperture 210 extending perpendicular to the axis-C into the internal passage of the hub body 202. The hub body 202 may be formed from a metal, such as aluminum, stainless steel, or brass. The hub body 202 may further include a tool coupling portion 212 (e.g., a hexagonal or other polygonal structure) to aid in torquing the hub body 202 onto the structure.

The hub body 202 receives the intermediate body 204 in the internal passage of the hub body 202. The intermediate body 204 has a first end 204A, and a second end 204B opposite of the first end 204A. The first end 204A of the intermediate body 204 is disposed within the internal passage of the hub body 202. The second end 204B of the intermediate body 204 extends axially outwards past the second end 202B of the hub body 202. The second end 204B of the intermediate body 204 includes external threads 214 for threadedly coupling to the gland nut 206. The intermediate body 204 further includes an internal passage 216 that extends through the first and second end 204A, 204B of the intermediate body 204. The internal passage 216 is configured such that the internal passage 216 may receive a portion of a cable therein.

The first end 204A of the intermediate body 204 mates with the internal passage of the hub body 202 at a mating point 218. The mating point 218 may be configured such that the mating point 218 comprises a spigot joint where a portion of the first end 204A of the intermediate body 204 is resistively retained within the internal passage of hub body 202. The first end 204A of the intermediate body 204 and the hub body 202 internal passage may further be configured to threadedly engage one another at the mating point 218. The first end 204A of the intermediate body 204 and the hub body 202 internal passage may include corresponding single ½ (one half) or ¼ (one fourth) threads at the mating point 218 to threadedly engage one another.

The first end 204A of the intermediate body 204 further includes a blind hole 220 that extends perpendicular to the axis-C into the intermediate body 204. The blind hole 220 is positioned on the intermediate body 204 such that the blind hole 220 is aligned with the hub body aperture 210. The hub body aperture 210 and the intermediate body blind hole 220 receives an engagement pin 222, 224 that secures the intermediate body to the hub body. The intermediate body may be formed from a metal, such as aluminum, stainless steel, or brass.

In the FIG. 5 embodiment, the engagement pin 222, 224 is a grub screw. The hub body aperture 210 and the intermediate body blind hole 220 may be configured to receive the grub screw 222. The hub body aperture 210 and intermediate body blind hole 220 may threadedly engage the grub screw 222. The grub screw 222 may include a plurality of threads that mate and fasten to the threads of the hub body aperture 210 and intermediate blind hole 220. Fastening the grub screw 222 to the hub body aperture 210 and intermediate blind hole 220 secures the intermediate body 204 to the hub body 202.

In the FIG. 6 embodiment, the engagement pin 222, 224 is a spring-loaded plunger 224. The hub body aperture 210 and the intermediate body blind hole 220 may be configured to receive the spring-loaded plunger 224. The hub body aperture 210 and intermediate body blind hole 220 may resistively retain the spring-loaded plunger 224. Inserting the spring-loaded plunger 224 into the hub body aperture 210 and intermediate blind hole 220 secures the intermediate body 204 to the hub body 202.

The cable gland assembly further includes an elastomer ring 226 that is disposed around the hub body 202. The elastomer ring 226 covers the hub body aperture 210 to prevent direct access to the engagement pin 222, 224. The elastomer ring 226 further prevents debris or other contaminates from entering the hub body aperture 210. The elastomer ring 226 may further be configured to resistively retain the spring-loaded plunger 224.

The cable gland assembly may further include a curable scaling compound disposed within the internal passage 216 of the intermediate body 204 proximate to the first end 204A of the intermediate body 204. When cured, the sealing compound serves as a sealant within the cable gland assembly 200 that restricts the passage of gasses, vapor, or flames into and through the cable gland assembly 200.

The gland nut 206 includes a first end 206A and a second end 206B opposite of the first end 206A. The gland nut 206 further includes an internal passage that extends through the first and second ends 206A, 206B of the gland nut 206. The gland nut 206 internal passage is configured to receive a portion of the cable therethrough. The first end 206A of the gland nut 206 includes an opening that is sized to receive the second end 204B of the intermediate body 204. The first end 206A of the gland nut 206 includes internal threads 228 that are configured to mate with and threadedly engage the external threads 214 of the second end 204B of the intermediate body 204. The second end 206B of the gland nut 206 includes a shoulder 230 such that the opening at the first end 206A is wider than the opening at the second end 206B. The gland nut 206 may be formed from a metal, such as aluminum, stainless steel, or brass. The second end 202B of the hub body 202 is sized such that the first end 206A of the gland nut 206 fits within the internal passage of the hub body 202. The cable gland assembly 200 may further include an O-ring 232 disposed between the first end 206A of the gland nut 206 and the second end 202B of the hub body 202. The O-ring 232 is configured to resistively retain the first end 206A of the gland nut 206 within the internal passage of the hub body 202 at the second end 202B of the hub body 202.

The cable gland assembly 200 may further includes a garter spring 234, a sleeve 236, a bushing 238, and a washer 240 disposed within the internal passage of the gland nut 206. The garter spring 234 is positioned between the second end 204A of the intermediate body 204 and the sleeve 236. The sleeve 236 is positioned between the garter spring 234 and the bushing 238. The sleeve 236 is configured to engage the garter spring 234 and the bushing 238 such that the sleeve 236 axially compresses the garter spring 234 and the bushing 238. The sleeve 238 may be formed from plastic or metal, such as aluminum, stainless steel, or brass. The washer 240 is disposed between the bushing 238 and the shoulder 230 of the gland nut 206 proximate to the second end 206B of the gland nut 206. The washer 240 distributes the load applied by the shoulder 230 of the gland nut 206 when the cable gland assembly 200 is assembled. The washer 240 may be comprised of or formed from. for example, plastic, such as a polyamide.

When the cable gland assembly 200 is assembled, the garter spring 234 is compressed between the second end 204A of the intermediate body 204 and the sleeve 236. When compressed, the garter spring 234 engages and surrounds the cable to create a grounding connection. The garter spring 234 may comprise or be formed from, for example, metal, such as stainless steel with copper flash coating.

The bushing 238 may comprise a bushing body 242 having a generally annular shape with an interior surface defining a bushing opening 244 extending through first and second ends 242A, 242B of the bushing body 242. A rib 246 is disposed on the interior surface of the bushing body 242. The rib 246 extends around the axis-A and extends radially inward from the interior surface toward the axis-C. In the illustrated embodiment, the rib 246 is a continuous annulus extending along the interior surface. The rib 246 may be disposed in a midplane extending through the bushing body 242 transverse to the axis-C at a location generally midway between the first and second ends 242A, 242B of the bushing body 242. The rib 246 may be disposed at other locations along the axis-C of the bushing body 246. The rib 246 has a suitable cross-sectional shape for engaging and sealing around the cable received in the cable gland assembly 100.

The cable is secured in the cable gland assembly 200 by the garter spring 234 and the bushing 238. The cable gland assembly 200 is configured such that the cable remains secured in the intermediate body 204 and the gland nut 206 even when the engagement pin 222, 224 is uncoupled from the hub body 202 and the intermediate body 204. As discussed above, when the gland nut 206 is threadedly coupled to the intermediate body 204, the gland nut 206 secures a portion of the cable in the internal passage of the gland nut 206 and the intermediate body 204 by compressing the cable in the garter spring 234 and the bushing 238. Therefore, so long as the gland nut 206 is threadedly coupled to the intermediate body 204, then the garter spring 234 and bushing 238 remain in a compressed state such that the cable is secured therein. This allows the engagement pin 222, 224 to be uncoupled from the cable gland assembly without compromising the securement of the cable. After the engagement pin 222, 224 is uncoupled from the hub body 202, then the intermediate body 204 can be removed from the hub body 202. Once the intermediate body 204 is removed from the hub body 202, an operator can apply the compound sealant or inspect previously applied compound sealant in the internal passage 216 at the first end 204A of the intermediate body 204.

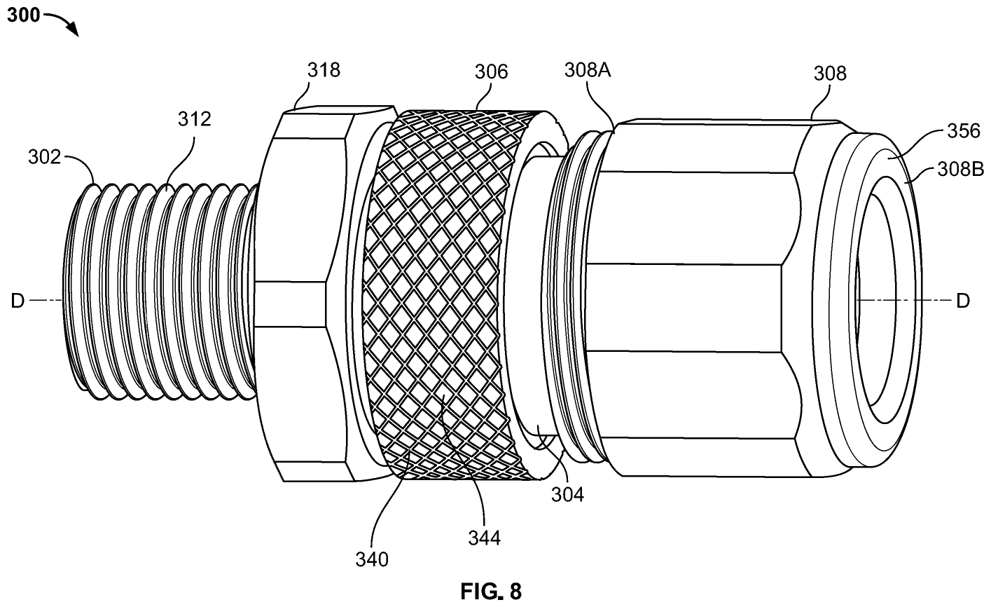

A third exemplary embodiment of a cable gland assembly 300 that extends along an axis-D is depicted in FIGS. 7 and 8. The cable gland assembly 300 includes a hub body 302, an intermediate body 304, a union collar 306, and a gland nut 308, wherein the cable gland assembly 300 is configured to secure a portion of a cable 310 therein. The hub body 302 has a first end 302A, and a second end 302B opposite to the first end 302A. The hub body 302 further includes an internal passage that extends through the first end 302A and the second end 302B of the hub body 302. The first end 302A of the hub body 302 includes external connection threads 312 for threadedly coupling the hub body to a device, an enclosure, or other structure. The hub body 302 further includes a second end 302B having an aperture 314 that receives a ball bearing 316. The aperture 314 extends through the hub body 302 such that the aperture 314 is in fluid communication with the internal passage of the hub body 302. The hub body 302 may be formed from a metal, such as aluminum, stainless steel, or brass. The hub body 302 further includes a tool coupling portion 318 (e.g., a hexagonal or other polygonal structure) to aid in torquing the hub body 302 onto the structure.

The hub body 302 receives the intermediate body 304 in the internal passage of the hub body 302. The intermediate body 304 has a first end 304A, and a second end 304B opposite of the first end 304A. The intermediate body 304 further includes an internal passage 320 that extends through the first and second end 304A, 304B of the intermediate body 304. The first end 304A of the intermediate body 304 is disposed within the internal passage of the hub body 302. The second end 304B of the intermediate body 304 extends axially outwards past the second end 302B of the hub body 302. The second end 304B of the intermediate body 304 includes a channel 322 disposed at a first position 324 on the exterior surface of the intermediate body 304. The channel 322 is disposed at the first position 324 of the exterior surface of the intermediate body 304 such that that the channel 322 aligns with the aperture 314 in the hub body 302 when the intermediate body 304 is disposed in the hub body 302 internal passage. The channel 322 is configured such that it receives the ball bearing 316 through the aperture 314. The second end 304B of the intermediate body 304 further includes external threads 326 disposed at a second position 328 of the exterior surface of the intermediate body 304. The external threads 326 of the second end 304B of the intermediate body 304 are configured to mate with and threadedly couple to the gland nut 308. The second position 328 of the exterior surface is axially rearward of the first position 324 of the exterior surface such that the channel 322 is positioned between the tool coupling portion 318 of the hub body 302 and the external threads 326 of the second end 304B of the intermediate body 304. The internal passage 320 of the intermediate body 304 further includes a step transition 330 proximate to the second end 304B of the intermediate body 304.

The intermediate body 304 may further include a brush dam 332 disposed within the internal passage of the intermediate body 304. The brush dam 332 includes an annular filament holder 334 and a plurality of individual filaments 336 that extend radially inward from the annular filament holder 334 to define an average inner radial extent that is less than the radius defined by the annular filament holder 334. The free ends of the of the filament 334 define a longitudinal opening 338 extending through the brush dam 336. The filaments 334 may be comprised of or formed form any suitable material such as but not limited to plastic. nylon, polypropylene, polystyrene, Tampico, horsehair, metal wire. etc. The filaments 334 are generally flexible or resiliently deflectable along the length of the filaments 334.

The brush dam 332 is configured to permit the cable 310 to pass through the opening 338 while still creating a barrier between the first end 304A and second end 304B of the intermediate body 304 to inhibit the flow of a curable sealing compound that is disposed within the intermediate body 304. The sealing compound applied in the internal passage 320 of the intermediate body 304 is positioned axially forward of the brush dam 332. When cured, the sealing compound serves as a sealant within the cable gland assembly 300 that restricts passage of gases, vapor, or flames into and through the cable gland assembly 300.

The union collar 306 includes a first end 306A, and a second end 306B opposite of the first end 306A. The union collar 306 is substantially ring shaped such that the union collar 306 includes an axially exterior surface 340 and an axially interior surface 342. The union collar 306 may include a grip feature 344 disposed along the axially exterior surface 340. The axially interior surface 342 of the union collar 306 defines an internal passage 346 that extends through the first and second ends of the union collar 306A, 306B. The internal passage 346 of the union collar 306 is sized such that the internal passage 346 receives the second end 302A of the hub body 302. The axially interior surface 342 of the union collar 306 further includes a projection 348 that extends perpendicular to the axis-D from the axially interior surface.

The union collar 306 is axially slidable between a first position and a second position. In the first position the projection 348 is aligned with the hub body aperture 314 and the intermediate body channel 322 such that the projection 348 engages the ball bearing 316. In the first position, the ball bearing 316 is retained in the aperture 314 and the channel 322 to resistively retain the intermediate body 304 in the hub body 302. The ball bearing 316 and projection 348 act in unison as a retention pin to resist axial movement of the intermediate body 304 to retain the intermediate body 304 in the internal passage of the hub body 302. In the second position, the union collar 306 is pulled axially towards the tool coupling portion 318 of the hub body 302 to disengage the projection 348 from the ball bearing 316. Disengaging the projection 348 from the ball bearing 316 allows the ball bearing 316 to release from the hub body aperture 314 and the intermediate body channel 322. When the ball bearing 316 is released, it allows the intermediate body 304 to be removed from the internal passage of the hub body 302.

The union collar 306 may further include a retention spring 350 disposed between the tool coupling portion 318 of the hub body 302 and projection 348 of the axially interior surface 342 of the union collar 306. The retention spring 350 is configured to resistively retain the union collar 306 in the first position such that the retention spring 350 resists axial movement of the union collar 306 towards the first end 302A of the hub body 302. The retention spring 350 is compressed in the second position by the axial movement of the projection 348. The union collar 306 may further include a retaining ring 352 disposed at the second end of the union collar 306. The retaining ring 352 is configured to prevent the ball bearing 316 from falling out of the union collar 306 when in the second position. The union collar 306 may be formed from a metal, such as aluminum, stainless steel, or brass.

The gland nut 308 includes a first end 308A, and a second end 308B opposite of the first end 308A. The gland nut 308 further includes an internal passage that extends through the first and second ends 308A, 308B of the gland nut 308. The gland nut 308 internal passage is configured to receive a portion of the cable 310 therethrough. The first end 308A of the gland nut 308 includes an opening that is sized to receive the second end 304B of the intermediate body 304. The first end 308A of the gland nut 308 includes internal threads 354 that are configured to mate with and threadedly engage the external threads 326 of the second end 304B of the intermediate body 304. The second end 308B of the gland nut 308 includes a shoulder 356 such that the opening at the first end 308A is wider than the opening at the second end 308B. The gland nut 308 may be formed from a metal, such as aluminum, stainless steel, or brass.

The cable gland assembly 300 further includes a garter spring 358, a sleeve 360, a bushing 362, and a washer 364 disposed within the internal passage of the gland nut 308. The garter spring 358 is positioned between the step transition 330 of the internal passage 320 of the intermediate body 304 and the sleeve 360. The sleeve 360 is positioned between the garter spring 358 and the bushing 362. The sleeve 360 is configured to engage the garter spring 358 and the bushing 362 such that the sleeve 360 axially compresses the garter spring 358 and the bushing 362. The sleeve 360 may be comprised of or formed from, for example, plastic or metal, such as aluminum, stainless steel, or brass. The washer 364 is disposed between the bushing 362 and the shoulder 356 of the gland nut 308 proximate to the second end 308B of the gland nut 308. The washer 364 distributes the load applied by the shoulder 356 of the gland nut 308 when the cable gland assembly 300 is assembled. The washer 364 may be comprised of or formed from, for example, plastic, such as a polyamide.

When the cable gland assembly 300 is assembled, the garter spring 358 is compressed between the step transition 330 of the intermediate body 304 and the sleeve 360. When compressed the garter spring 358 engages and surrounds the cable 310 to create a grounding connection. The garter spring 358 may be formed from metal, such as stainless steel with copper flash coating.

The bushing 362 may comprise a bushing body 368 having a generally annular shape with an interior surface defining a bushing opening 370 extending through first and second ends of the bushing body 368A, 368B. A rib 372 is disposed on the interior surface of the bushing body 368. The rib 372 extends around the axis-D and extends radially inward from the interior surface toward the axis-D. In the illustrated embodiment, the rib 372 is a continuous annulus extending along the interior surface. The rib 372 may be disposed in a midplane extending through the bushing body 368 transverse to the axis-D at a location generally midway between the first and second ends of the bushing body 368. The rib 372 may be disposed at other locations along the axis-D of the bushing body 368. The rib 372 has a suitable cross-sectional shape for engaging and sealing around the cable 310 received in the cable gland assembly 300.

The cable 310 is secured in the cable gland assembly 300 by the garter spring 358 and the bushing 366. The cable gland assembly 300 is configured such that the cable 310 remains secured in the intermediate body 304 and the gland nut 308 even when the union collar 306 releases the ball bearing 316 in the second position. As discussed above, when the union collar 306 is in the first position the intermediate body 304 is retained in the internal passage of the hub body 302 by the ball bearing 316. However, the cable 310 in retained in the internal passage of the gland nut 308, independent of the union collar 306, by compressing the cable 310 in the garter spring 358 and the bushing 366. Therefore, so long as the gland nut 308 is threadedly coupled to the intermediate body 304, then the garter spring 358 and bushing 366 remain in a compressed state such that the cable 310 is secured therein. This allows the union collar 306 to be moved to the second position to release the ball bearing 316 from the hub body aperture 314 and intermediate body channel 322 without compromising the securement of the cable 310. After the ball bearing 316 is released then the intermediate body 304 can be removed from the hub body 302. Once the intermediate body 304 is removed from the hub body 302, an operator can apply the compound sealant or inspect previously applied compound sealant in the internal passage 320 at the first end 304A of the intermediate body 304.

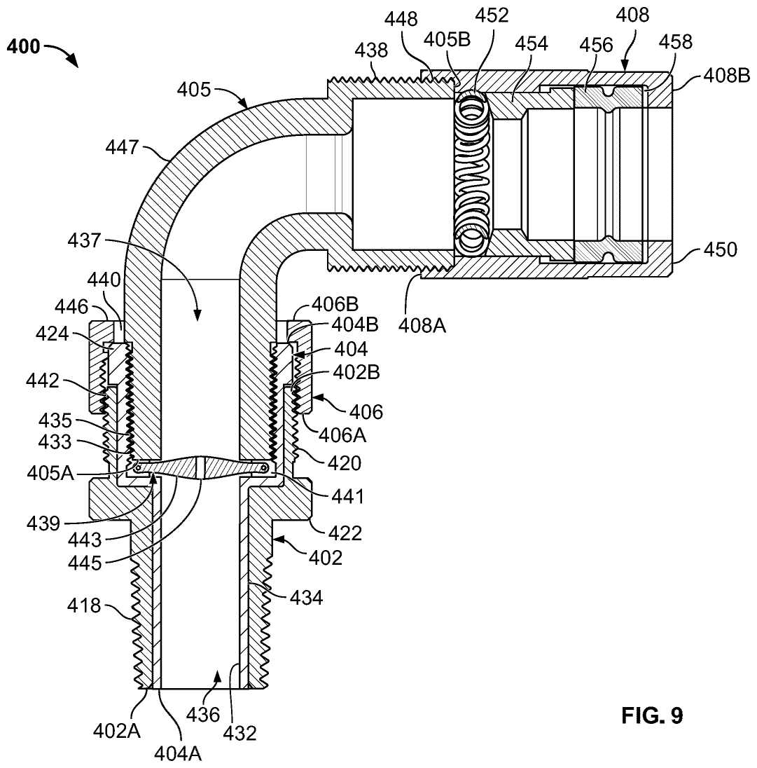

Referring now to FIG. 9, which depicts a fourth exemplary embodiment of a cable gland assembly 400. The cable gland assembly 400 includes a hub body 402, an intermediate body 404, an elbow body 405, a union nut 406, and a gland nut 408, wherein the cable gland assembly 400 is configured to secure a portion of a cable therein. The hub body 402 has a first end 402A with external connection threads 418 for threading into a device, an enclosure, or other structure. The hub body 402 further includes a second end 402B having a multistart threaded portion 420 that threadedly mates with the union nut 406. The hub body 402 further includes an internal passage that extends through the first end 402A and the second end 402B of the hub body 402. The hub body 402 may be formed from a metal, such as aluminum, stainless steel, or brass. The hub body 402 further includes a tool coupling portion 422 (e.g., a hexagonal or other polygonal structure) to aid in torquing the hub body 402 onto the structure.

The hub body 402 receives the intermediate body 404 in the internal passage of the hub body 402. The intermediate body 404 has a first end 404A and a second end 404B opposite of the first end 404A. The first end 404A of the intermediate body 404 is disposed within the internal passage of the hub body 404. The second end 404B of the intermediate body 404 extends axially outwards past the second end 402B of the hub body 402. The intermediate body 404 further includes an internal passage 432 that extends through the first and second end 404A, 404B of the intermediate body 404. The internal passage 432 further includes an internal threaded portion 433. The internal passage 432 is configured to receive a portion of a cable therein. The intermediate body 404 may be formed from a metal, such as aluminum, stainless steel, or brass.

The internal passage 432 of the intermediate body 404 receives a first end 405A of the elbow body 405 through the second end 404B of the intermediate body 404. The first end 405A of the elbow body 405 includes external threads 435 that engage the internal threaded portion 433 of the intermediate body 404. The elbow body 405 includes a second end 405B and an internal passage 437 extending therethrough. The elbow body includes an angular bend 447 disposed between the first and second ends 405A, 405B, such that the elbow body 447 is curved. The second end 405B of the elbow body 405B further includes external threads 438. As depicted in FIG. 9, the angular bend 447 is a right-angle, i.e., a ninety-degree (90°) bend, such that the first end 405A and the second end 405B extend in orthogonal axes. In further embodiments, the angular bend 447 is an acute-angle bend at an angle between zero-degrees) (0°) and ninety-degrees (90°). In even further embodiments, the angular bend 447 is an obtuse-angle bend at an angle between ninety-degrees (90°) and one-hundred-eighty-degrees (180°). The elbow body 405 may be formed from a metal, such as aluminum, stainless steel, or brass. The elbow body 405 is particularly advantageous in situations where space is limited around or along the structure that receives an exemplary cable gland assembly. Additionally, the elbow body 405 is advantageous for relieving stress on a cable that would otherwise extend angularly from a linear cable gland assembly.

The cable gland assembly 400 further includes a flamepath 434. The flamepath 434 is a thin passage disposed between the interior surface of the hub body 402 and the exterior surface of the intermediate body 404. Moreover, the cable gland assembly 400 includes a compound chamber 436 disposed within the intermediate body 404 proximate to the first end 404A of the intermediate body 404. The compound chamber 436 is configured to receive a curable sealing compound (also referred herein as a compound sealant). When cured, the sealing compound serves as a sealant within the cable gland assembly 400 that restricts the passage of gases, vapor, or flames into and through the cable gland assembly 400. Suitable examples of sealing compounds include, but are not limited to, epoxy fillers and Chico® sealing compounds commercially available from Eaton Corporation PLC.

The intermediate body 404 may further include a brush dam 439 disposed within the internal passage 432 of the intermediate body 404. The brush dam 439 includes an annular filament holder 441 and a plurality of individual filaments 443 that extend radially inward from the annular filament holder 441 to define an average inner radial extent that is less than the radius defined by the annular filament holder 441. The free ends of the of the filament 443 define an opening 445 extending through the brush dam 439. The filaments 443 may be comprised of or formed form any suitable material such as but not limited to plastic, nylon. polypropylene, polystyrene, Tampico, horschair, metal wire, etc. The filaments 443 are generally flexible or resiliently deflectable along the length of the filaments 443. The brush dam 439 permits a portion of a cable to pass through the opening 445 while still creating a barrier between the first end 404A of the intermediate body 404 and the first end 405A of the elbow body 405 to inhibit the flow of the curable sealing compound that is disposed within the compound chamber 436.

The union nut 406 includes a first end 406A, and a second end 406B opposite of the first end 406A. The union nut 406 further includes an internal passage 440 that extends through the first and second ends 406A, 406B. The first end of the union nut 406A includes a multistart threaded portion 442. The multistart threaded portion 442 includes multistart threads that are configured to mate and couple to the multistart threads 420 of the hub body 402. The union nut 406 multistart threads 442 are disposed along an axially inner surface 444 of the union nut 406. The multistart threaded portion 442 of the union nut 406 and the multistart threaded portion 420 of the hub body 402 are configured as quick connectors such that the union nut 406 can be tightened to threadedly engage the hub body 402 and loosened to threadedly disengage from the hub body 402 in one or fewer turns. In alternate embodiments, the union nut 406 can be tightened to threadedly engage the hub body 402 and loosened to threadedly disengage from the hub body 402 in two or fewer turns. In alternate embodiments, the multistart threaded portions 420, 442 of the hub body 402 and union nut 406 may be comprised of standard threaded portions.

The second end 406B of the union nut 406 includes a shoulder 446 such that the opening at the first end 406B of the union nut 406 is wider than the opening at the second end 406B of the union nut 406. The internal passage 440 of the union nut 406 receives the intermediate body 404 and elbow body 405 such that a collar 424 of intermediate body 404 abuts the union nut shoulder 446. The union nut shoulder 446 restricts the axial movement of the intermediate body 404. The shoulder 446 further restricts the axial movement of the intermediate body 404 such that tightening the multistart threaded portion 442 of the union nut 406 to the multistart threaded portion 420 of the hub body 402 secures the intermediate body 404 in the internal passage of the hub body 402. The intermediate body 404 cannot be removed from the internal passage of the hub body 402 unless and until the union nut 406 is uncoupled from the hub body 402 such that the union nut shoulder 446 does not abut the intermediate body collar 424.

Referring still to FIG. 9, the gland nut 408 includes a first end 408A, and a second end 408B opposite of the first end 408A. The gland nut 408 further includes an internal passage that extends through the first and second ends 408A, 408B of the gland nut 408. The gland nut internal passage is configured to receive a portion of the cable therethrough. The first end 408A of the gland nut 408 includes an opening that is sized to receive the second end 405B of the elbow body 405. The first end 408A of the gland nut 408 includes internal threads 448 that are configured to mate with and threadedly engage the external threads 438 of the second end 405B of the elbow body 405. The second end 408B of the gland nut 408 includes a shoulder 450 such that the opening at the first end 408A is wider than the opening at the second end 408B. The gland nut may be formed from a metal, such as aluminum, stainless steel, or brass.

The cable gland assembly 400 further includes a garter spring 452, a sleeve 454, a bushing 456, and a washer 458 disposed within the internal passage of the gland nut 408. The garter spring 452 is positioned between the second end 404B of the intermediate body 404 and the sleeve 454. The sleeve 454 is positioned between the garter spring 452 and the bushing 456. The sleeve 454 is configured to engage the garter spring 452 and the bushing 456 such that the sleeve 454 axially compresses the garter spring 452 and the bushing 456. The sleeve 454 may be comprised of or formed from, for example, plastic or metal, such as aluminum, stainless steel, or brass. The washer 458 is disposed between the bushing 456 and the shoulder 450 of the gland nut 408 proximate to the second end 408B of the gland nut 408. The washer 458 distributes the load applied by the shoulder 450 of the gland nut 408 when the cable gland assembly 400 is assembled. The washer 458 may be constructed of, for example, plastic, such as a polyamide.

When the cable gland assembly is assembled with a cable disposed therein, the garter spring 452 is compressed between the second end 405B of the elbow body 405 and the sleeve 454. When compressed, the garter spring 452 engages and surrounds a portion of the cable to create a grounding connection. Additionally, the garter spring 452 may be configured to act as an armor stop which limits the insertion of a cable jacket or a cable armor that surrounds the cable by stripping the cable jacket and the cable armor to expose the internal wires or cables. The garter spring 452 may be formed from metal, such as stainless steel with copper flash coating.

The cable gland assembly 400 is configured such that a portion of the cable remains secured in the intermediate body 404, the elbow body 405, and the gland nut 408 even when the union nut 406 is uncoupled form the hub body 402. This allows the union nut 406 to uncouple from the cable gland assembly 400 without compromising the securement of the cable.

After the union nut 406 is uncoupled from the hub body 402, then the intermediate body 404, with the elbow body 405 threadedly engaged therein, can be removed from the internal passage of the hub body 402. Once the intermediate body 404 is removed from the internal passage of the hub body 402, an operator can apply the compound sealant or inspect previously applied compound sealant in the compound chamber 436. Accordingly, an operator only needs to untorque the union nut 406 to remove the intermediate body 404 with threadedly engaged elbow body from the hub body 402 because the intermediate body 404 is retained in the hub body 402 without fasteners or threads.

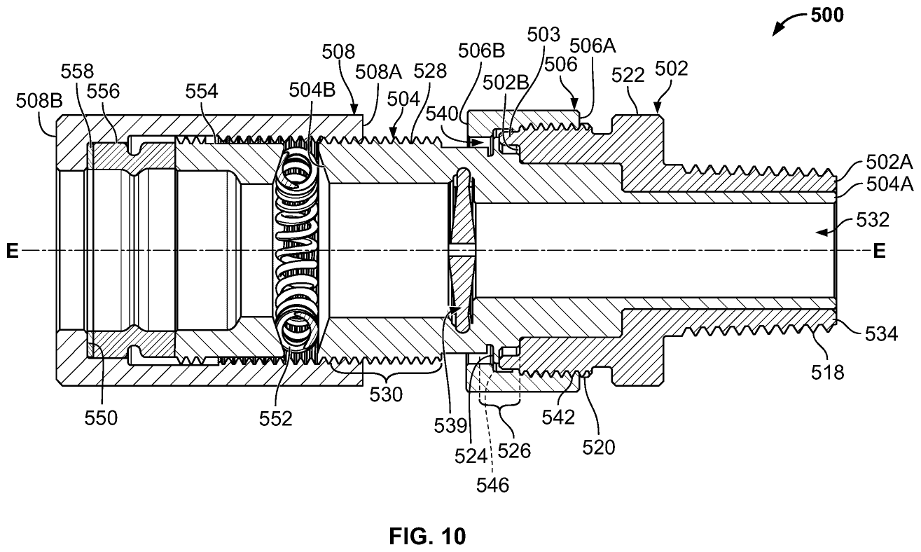

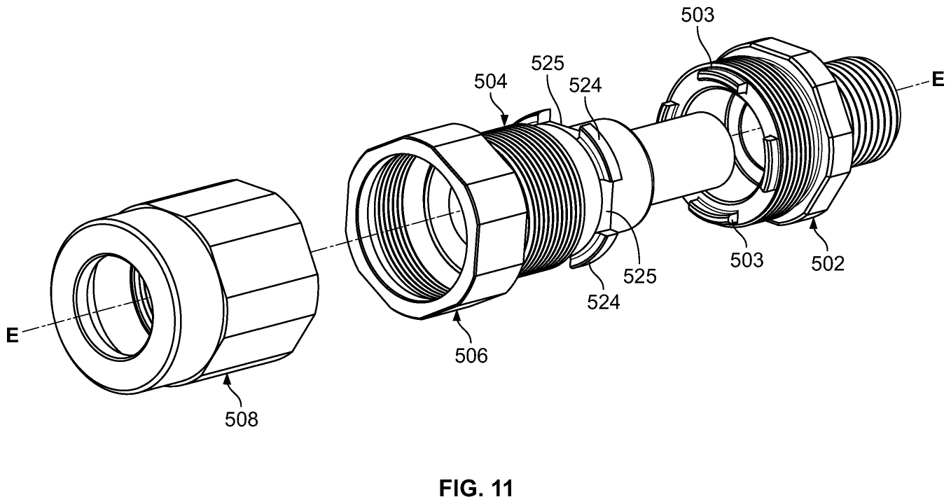

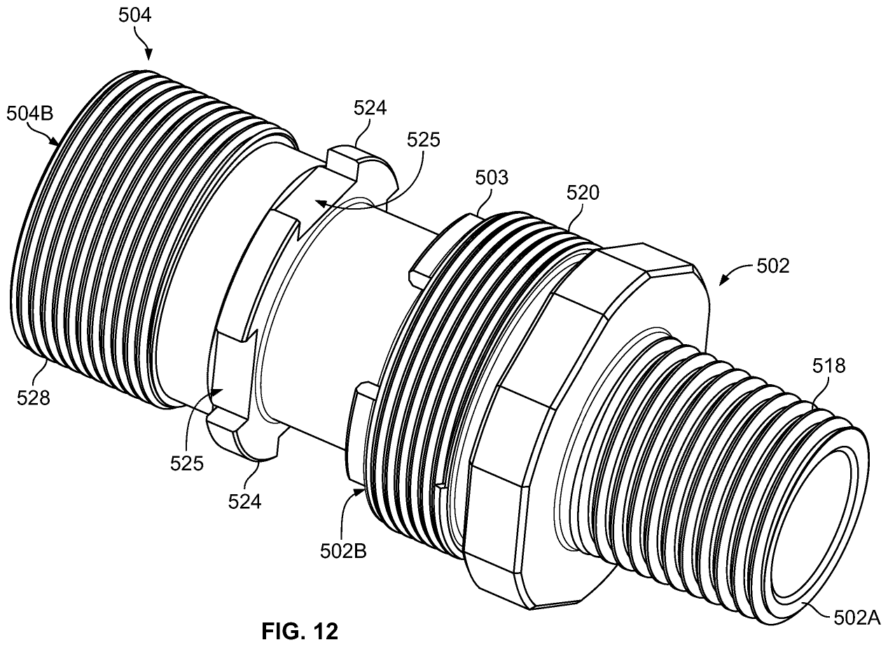

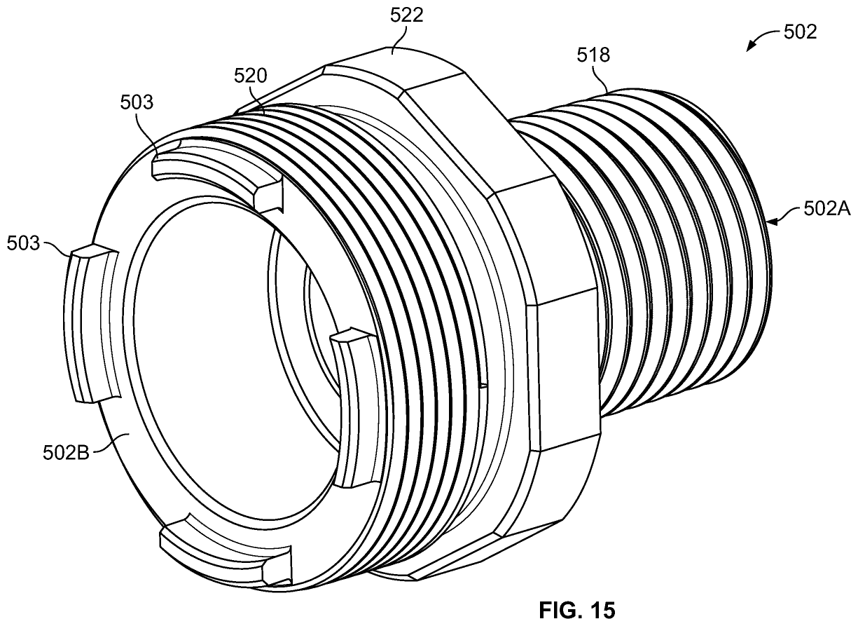

Referring now to FIGS. 10-15, which depict a fifth exemplary embodiment of a cable gland assembly 500 that extends along an axis-E. Similar to the previously disclosed embodiments, the cable gland assembly 500 is a flame proof cable gland assembly that is configured to seal the junction between a cable and a device or a structure into which the cable is extending. As explained in more detail below, the cable gland assembly 500 includes a union nut 506 that is threadedly coupled to a hub body 502 with a quick connector such that the union nut 506 can be uncoupled from the hub body 502 within one turn of the union nut 506. The other components of the cable gland assembly 500, also described below, are illustrative and may be of other designs or constructions.

The cable gland assembly 500 includes a hub body 502, an intermediate body 504, a union nut 506, and a gland nut 508, wherein the cable gland assembly 500 is configured to secure a portion of a cable (not shown) therein. The hub body 502 has a first end 502A with external connection threads 518 for threading into and connecting to a device, an enclosure, or other structure. The hub body 502 further includes a second end 502B having a multistart threaded portion 520 that includes multistart threads for threadedly mating with the union nut 506. The hub body 502 further includes an internal passage that extends through the first end 502A and the second end 502B of the hub body 502. The hub body 502 may be formed from a metal, such as aluminum, stainless steel, or brass. The hub body 502 further includes a tool coupling portion 522 (e.g., a hexagonal or other polygonal structure) to aid in torquing the hub body 502 onto the structure. The hub body 502 further includes at least one axial projection 503 extending axially outward from the second end 502B of the hub body 502. The exemplary hub body 502 depicted in FIGS. 10-17 includes four axial projections 503 evenly spaced about the circumference of the second end 502B of the hub body 502. In an alternative embodiment (not shown), the hub body may have one, two, or three axial projections. In another alternative embodiment (not shown), the hub body may have five or more axial projections.

The hub body 502 receives the intermediate body 504 in the internal passage of the hub body 502. The intermediate body 504 has a first end 504A and a second end 504B opposite of the first end 504A. The first end 504A of the intermediate body 504 is disposed within the internal passage of the hub body 504. In the illustrated embodiment, the first end 504A of the intermediate body 504 is flush with the first end 502A of the hub body 502 when the cable gland assembly 500 is assembled. In an alternative embodiment, the first end of the intermediate body is recessed from the end of the hub body.

The second end 504B of the intermediate body 504 extends axially outwards from the internal passage of the hub body 504 past the second end 502B of the hub body 502. The intermediate body 504 includes at least one radial projection 524 extending from and disposed around a first portion 526 of the exterior surface of the intermediate body 504. The first portion 526 of the exterior surface of the intermediate body 504 is positioned toward the middle of the intermediate body 504 such that the radial projection 524 is between the first end 504A and the second end 504B of the intermediate body 504.

The exemplary intermediate body 504 depicted in FIGS. 10-15 includes four radial projections 524 extending radially from a circumference of the intermediate body. The radial projections 524 are positioned such that the radial projections 524 are equally spaced apart and distributed along the circumference of the intermediate body 504. The intermediate body 504 further includes a projection gap 525 disposed between the radial projections 524 along the circumference of the intermediate body 504. In alternative embodiments, (not shown), the intermediate body includes two or three radial projections. In another alternative embodiments (not shown), the intermediate body includes five or more radial projections. In all embodiments, the number of radial projections on the intermediate body corresponds to the number of axial projections on the hub body.

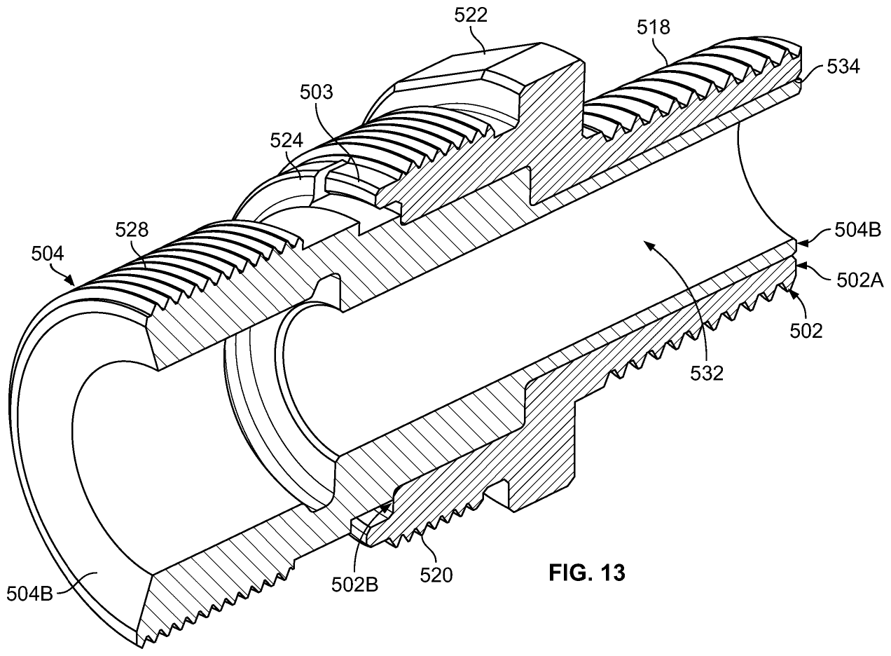

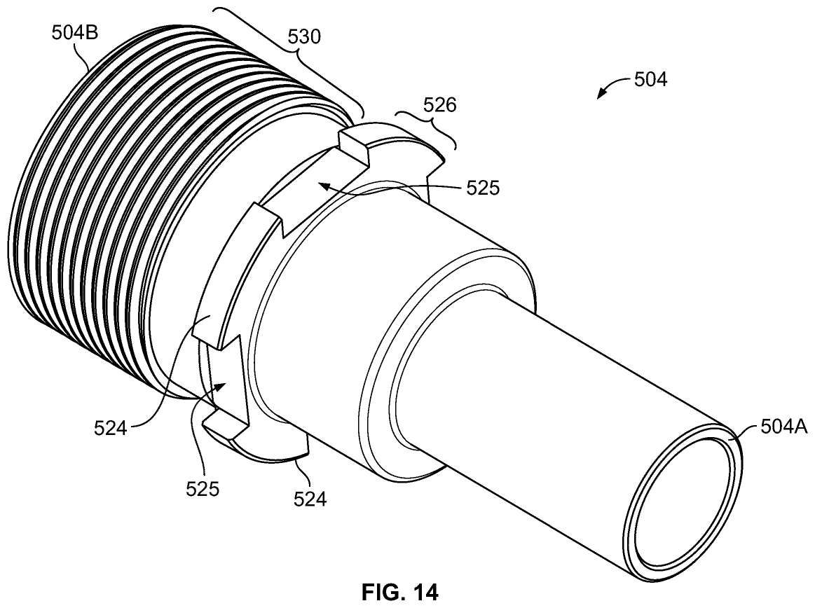

Referring now to FIG. 13, the radial projections 524 of the intermediate body 504 are spaced apart such that projection gaps 525 of the intermediate body 504 align with and receive the axial projections 503 of the hub body 502 when the intermediate body 504 is disposed within the hub body 502. The radial projections 524 and axial projections 503 abut one another such that the abutment restricts rotational movement of the intermediate body 504 within the hub body 502. Restricting rotational movement prevents the intermediate body 504 from rotating as the gland nut 508 is secured onto the intermediate body 504, which could potentially loosen the engagement between the hub body 502 and the union nut 506. A loose engagement between the hub body 502 and the union nut 506 can compromise the functionality and the safety of the cable gland system 500.

Referring again to FIGS. 10-15, the second end 504B of the intermediate body 504 further includes external threads 528 disposed around a second portion 530 of the exterior surface of the intermediate body 504. The external threads 528 of the second end 504B of the intermediate body 504 are configured to mate with and couple to the gland nut 502. The second portion 530 of the exterior surface of the intermediate body 504 is axially rearward of the first portion 526 of the exterior surface of the intermediate body 504 such that the radial projections 524 are positioned between the second end 502B of the hub body 502 and the external threads 528 of the intermediate body 504.

The intermediate body 504 further includes an internal passage 532 that extends through the first and second ends 504A, 504B of the intermediate body 504. The internal passage 532 is configured to receive a portion of the cable therein. A brush dam 539 is disposed within the internal passage 532 of the intermediate body 504. The brush dam 539 is consistent with the brush damn 439 described above and depicted in FIG. 9. The intermediate body 504 may be formed from a metal, such as aluminum, stainless steel, or brass.

The cable gland assembly 500 may further include a flamepath 534. The flamepath 534 is a thin passage disposed between the interior surface of the hub body 502 and the exterior surface of the intermediate body 504. The flamepath 534 is configured to permit hot or volatile gasses that are contained within the structure to slowly dissipate from the structure. The flamepath 534 alleviates buildup of gasses within the structure, which if not alleviated, could lead to catastrophic failure of the system. Furthermore, the flamepath 534 may be configured such that it allows the hot gasses that are dissipating through the flamepath 534 to cool as the gasses travel through the flamepath 534 and out of the cable gland assembly 500.

The union nut 506 includes a first end 506A, and a second end 506B opposite of the first end 506A. The union nut 506 further includes an internal passage 540 that extends through the first and second ends 506A, 506B. The first end of the union nut 506A includes a multistart threaded portion 542. The multistart threaded portion 542 includes multistart threads that are configured to mate and couple to the multistart threads 520 of the hub body 502. The union nut 506 multistart threads 542 are disposed along an axially inner surface of the union nut 506. The multistart threaded portion 542 of the union nut 506 and the multistart threaded portion 520 of the hub body 502 are configured as quick connectors such that the union nut 506 can be tightened to threadedly engage the hub body 502 and loosened to threadedly disengage from the hub body 502 in one or fewer turns. In alternate embodiments, the union nut 506 can be tightened to threadedly engage the hub body 502 and loosened to threadedly disengage from the hub body 502 in two or fewer turns. In alternate embodiments, the multistart threaded portions 520, 542 of the hub body 502 and union nut 506 may be comprised of standard threaded portions.

The second end 506B of the union nut 506 includes a shoulder 546 such that the opening at the first end 506B of the union nut 506 is wider than the opening at the second end 506B of the union nut 506. The internal passage 540 of the union nut 506 receives the intermediate body 504 such that the radial projections 524 of intermediate body 504 abuts the union nut shoulder 546. The shoulder 546 restricts the axial movement of the intermediate body 504 along the axis-E such that intermediate body 504 can only be inserted into the internal passage 540 of the union nut 506 until the radial projection 524 makes contact with the shoulder 546. The shoulder 546 further restricts the axial movement of the intermediate body 504 such that tightening the multistart threaded portion 542 of the union nut 506 to the multistart threaded portion 520 of the hub body 502 secures the intermediate body 504 in the internal passage of the hub body 502. The intermediate body 504 cannot be removed from the internal passage of the hub body 502 unless and until the union nut 506 is uncoupled from the hub body 502 such that the shoulder 546 of the union nut 506 does not abut the radial projections 524 of the intermediate body 504.

Referring again to FIGS. 10-15, the gland nut 508 includes a first end 508A, and a second end 508B opposite of the first end 508A. The gland nut 508 further includes an internal passage that extends through the first and second ends 508A, 508B of the gland nut 508. The gland nut internal passage is configured to receive a portion of the cable therethrough. The first end 508A of the gland nut 508 includes an opening that is sized to receive the second end 504B of the intermediate body 504. The first end 508 of the gland nut 508A includes internal threads 548 that are configured to mate with and threadedly engage the external threads 528 of the second end 504B of the intermediate body 504. The second end 508B of the gland nut 508 includes a shoulder 550 such that the opening at the first end 508A is wider than the opening at the second end 508B. The gland nut may be formed from a metal, such as aluminum, stainless steel, or brass.

The cable gland assembly 500 further includes a garter spring 552, a sleeve 554, a bushing 556, and a washer 558 disposed within the internal passage of the gland nut 508. The garter spring 552 is positioned between the second end 504B of the intermediate body 504 and the sleeve 554. The sleeve 554 is positioned between the garter spring 552 and the bushing 556. The sleeve 554 is configured to engage the garter spring 552 and the bushing 556 such that the sleeve 554 axially compresses the garter spring 552 and the bushing 556. The sleeve 554 may be comprised of or formed from, for example, plastic or metal, such as aluminum, stainless steel, or brass. The washer 558 is disposed between the bushing 556 and the shoulder 550 of the gland nut 508 proximate to the second end 508B of the gland nut 508. The washer 558 distributes the load applied by the shoulder 550 of the gland nut 508 when the cable gland assembly 500 is assembled. The washer 558 may be comprised of or formed from, for example, plastic, such as a polyamide.

When the cable gland assembly is assembled, the garter spring 552 is compressed between the second end 504B of the intermediate body 504 and the sleeve 554. When compressed, the garter spring 552 engages and surrounds the cable armor of the cable to create a grounding connection. Additionally, the garter spring 552 may be configured to act as an armor stop. The garter spring 552 may be formed from metal, such as stainless steel with copper flash coating.

The cable is secured in the cable gland assembly 500 by the garter spring 552 and the bushing 556. The cable gland assembly 500 is configured such that the cable remains secured in the intermediate body 504 and the gland nut 508 even when the union nut 506 is uncoupled form the hub body 502. As discussed above, when the gland nut 508 is threadedly coupled to the intermediate body 504, the gland nut 508 secures a portion of the cable in the intermediate body 504 and the gland nut 508 by compressing the cable in the garter spring 552 and the bushing 556. Therefore, so long as the gland nut 508 is threadedly coupled to the intermediate body 504, then the garter spring 552 and bushing 556 remain in a compressed state such that the cable is secured therein. This allows the union nut 506 to be uncoupled from the cable gland assembly 500 without compromising the securement of the cable.

After the union nut 506 is uncoupled form the hub body 502, then the intermediate body 504 can be removed from the internal passage of the hub body 502. Once the intermediate body 504 is removed from the internal passage of the hub body 502, an operator can apply the compound sealant or inspect previously applied compound sealant in the compound chamber 536 of the internal passage 532 of the intermediate body 504. Since the intermediate body 504 is received in the hub body 503 without fasteners or threads, then an operator only needs to untorque the union nut 506 to remove the intermediate body 504 to apply the compound sealant or inspect previously applied sealant.

In one embodiment, the cable gland assembly 500 has a ½ trade size fitting for use with 0.50 inch cables. The cable gland assembly 500 has an across corner width B-B of less than or equal to 1.24 inches with a sealing range of 0.50-0.78 inches. The cable gland assembly 500 is an improvement over conventional cable glands because to achieve a similar sealing range, the conventional cable glands have an across corner width that is greater than 1.24 in (inches).

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995). Also, to the extent that the terms “in” or “into” are used in the specification or the claims, it is intended to additionally mean “on” or “onto.” Furthermore, to the extent the term “connect” is used in the specification or claims, it is intended to mean not only “directly connected to,” but also “indirectly connected to” such as connected through another component or components.

While the present application has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the application, in its broader aspects, is not limited to the specific details, the representative apparatus and method, and illustrative examples shown and described. Accordingly, departures may be made from such details without departing from the spirit or scope of the applicant's general inventive concept.

What is claimed is:

1. A cable gland assembly comprising:
a hub body having a first end configured to threadedly couple to a structure and a second end opposite the first end, wherein an exterior portion of the second end of the hub body includes a multistart threaded portion, the hub body defining an internal passage;
an intermediate body extending along an axis, the intermediate body having a first end and a second end, the intermediate body defining an internal passage that is configured to receive a cable, the first end of the intermediate body is disposed within the internal passage of the hub body, the second end extending axially past the second end of the hub body, the second end further having an annular projection disposed around a first exterior portion of the second end of the intermediate body proximate to the second end of the hub body, the second end further having external threads extending axially past the annular projection along a second exterior portion of the intermediate body;
a union nut having a first end and a second end opposite the first end, the union nut defining an internal passage that receives the intermediate body and the second end of the hub body, the first end of the union nut threadedly engages the multistart threaded portion of the hub body, the second end of the union nut having a shoulder that abuts against the annular projection of the intermediate body, wherein tightening the union nut along the multistart threaded portion of the hub body secures the intermediate body in the internal passage of the hub body; and
a gland nut having a first end and a second end opposite the first end, the gland nut defining an internal passage configured to receive the cable, the first end of the gland nut threadedly engages the external threads of the second end of the intimidate body, the second end of the gland nut having a shoulder.

2. The cable gland assembly of claim 1, wherein the multistart threaded portions of the hub body and union nut tighten or loosen in one or fewer turns.

3. The cable gland assembly of claim 1, further comprising a bushing disposed within the gland nut, the bushing having a first end and a second end opposite the first end, wherein the second end of the bushing abutting the gland nut shoulder.

4. The cable gland assembly of claim 3, further comprising a washer disposed within the gland nut, the washer having a first side and a second side opposite the first side, wherein the second side of the washer abuts the second end of the bushing.

5. The cable gland assembly of claim 4, further comprising a garter spring disposed between the second end of the intermediate body and the first side of the washer, wherein the garter spring engages a portion of the cable to secure the cable within the cable gland assembly when the gland nut is tightened onto the intermediate body.

6. The gable gland assembly of claim 5, wherein the portion of the cable is secured in the cable gland assembly independently of the union nut.

7. The cable gland assembly of claim 1, further comprises a ½ trade size fitting with a sealing range of 0.50-0.78 in (inches) and an across corner width of 1.24 in (inches).

8. The cable gland assembly of claim 1, wherein the intermediate body includes a compound chamber in the first end of the intermediate body for receiving a sealing compound.

9. A cable gland assembly comprising:
a hub body extending along an axis having a first end configured to threadedly couple to a structure and a second end opposite the first end, the hub body defining an internal passage along the axis that is configured to receive a portion of a cable, the second end of the hub body including an aperture extending perpendicular to the axis into the internal passage of the hub body;
an intermediate body having a first end and a second end opposite the first end, the intermediate body defining an internal passage configured to receive a portion of the cable, wherein the first end of the intermediate body is received in the hub body, the first end of the intermediate body having a blind hole, wherein the blind hole is aligned with the hub body aperture and extends perpendicular to the axis into the intermediate body;
an engagement pin configured to be inserted into the hub body aperture and intermediate body blind hole to secure the intermediate body in the hub body; and
a gland nut having a first end and an opposite second end, the gland nut defining an internal passage configured to receive a portion of the cable, the first end of the gland nut receives the second end of the intermediate body such that the first end of the gland nut threadedly engages the threads of the second end of the intermediate body, the first end of the gland nut fits within the internal passage of the hub body.

10. The cable gland assembly of claim 9, wherein the engagement pin is a grub screw that threadedly engages a threaded portion of the hub body aperture and a threaded portion of the intermediate body blind hole.

11. The gland assembly of claim 9, wherein the engagement pin is a spring-loaded plunger.

12. The gland assembly of claim 9, further comprising an elastomer ring disposed around the hub body that covers the hub body aperture to prevent direct access to the engagement pin.

13. The gland assembly of claim 9, wherein the first end of the gland nut is resistively retained in the second end of the hub body.

14. The gland assembly of claim 13, further comprising an O-ring disposed between the first end of the gland nut and the second end of the hub body, wherein the O-ring resistively retains the first end of the gland nut within the internal passage of the hub body.

15. A cable gland assembly comprising:
a hub body having a first end configured threadedly couple to a structure and a second end opposite the first end, wherein the second end of the hub body includes an aperture that retains a ball bearing, the hub body defining an internal passage;
an intermediate body extending along an axis, the intermediate body having a first end and a second end, the intermediate body defining an internal passage that is configured to receive a cable, the first end of the intermediate body is disposed within the internal passage of the hub body, the first end further having a channel that is aligned with aperture in the hub body and the channel receives the ball bearing through the aperture in the hub body, the second end of the intermediate body extends axially past the second end of the hub body, the second end of the intermediate body having external threads;
a union collar having a first end and a second end opposite the first end, wherein the union collar is substantially ring shaped such that the union collar includes an axially exterior surface and an axially interior surface, the axially interior surface of the union collar defines an internal passage that receives the second end of the hub body, the axially interior surface includes a projection that engages the ball bearing when the union collar is in a first position and disengages the ball bearing when the union collar is in a second position; and
a gland nut having a first end and a second end opposite the first end, the gland nut defining an internal passage configure to receive the cable, the first end of the gland nut is configured to threadedly engage the external threads of the second end of the intermediate body, the second end of the gland nut having a shoulder.

16. The cable gland assembly of claim 15, further comprising a spring disposed between a tool coupling portion of the hub body and the axially interior surface of the union collar wherein the spring resists axial movement of the union collar toward the first end of the hub body.

17. The cable gland assembly of claim 16, wherein the spring resistively maintains the projection in the first position.

18. The cable gland assembly of claim 17, wherein the spring is compressed by axial movement of the union collar toward the first end of the hub body in the second position.

19. The cable gland assembly of claim 15, further comprising a compound chamber disposed proximate to the first end of the intermediate body for receiving a sealing compound.

20. The cable gland assembly of claim 19, wherein the internal passage of the intermediate body further includes a brush dam such that the brush dam is configured to allow passage of the cable through the internal passage of the intermediate body while retaining the sealing compound within the compound chamber.

21. A cable gland assembly comprising:
a hub body having a first end configured to threadedly couple to a structure and a second end opposite the first end, wherein an exterior portion of the second end of the hub body includes a multistart threaded portion, the hub body defining an internal passage;
an intermediate body extending along an axis, the intermediate body having a first end and a second end, the intermediate body defining an internal passage, the first end of the intermediate body is disposed within the internal passage of the hub body, the second end extending axially past the second end of the hub body, the second end further having a collar, the intermediate body having further having internal threads along a portion of the internal passage proximate to the second end of intermediate body;
an elbow body having a first end and a second end, the elbow body further having an angular bend disposed between the first end and second end of the elbow body, the elbow body defining an internal passage, the first end of the elbow body threadedly engages the internal threads of the intermediate body, the second end of the elbow body includes external threads;
a union nut having a first end and a second end opposite the first end, the union nut defining an internal passage that receives the first end of the intermediate body and the second end of the hub body, the first end of the union nut threadedly engages the multistart threaded portion of the hub body, the second end of the union nut having a shoulder that abuts against the intermediate body collar, wherein tightening the union nut along the multistart threaded portion of the hub body secures the intermediate body in the internal passage of the hub body; and
a gland nut having a first end and a second end opposite the first end, the gland nut defining an internal passage, the first end of the gland nut threadedly engages the external threads of the second end of the elbow body, the second end of the gland nut having a shoulder.

22. The cable gland assembly of claim 21, wherein the angular bend of the elbow body is an acute-angle bend.

23. The cable gland assembly of claim 21, wherein the angular bend of the elbow body is a right-angle bend.

24. The cable gland assembly of claim 21, wherein the angular bend of the elbow body is an obtuse-angle bend.
